(19) United States
(12) Patent Application Publication
(10) Pub. No.: US 2005/0288412 A1
(43) Pub. Date: Dec. 29, 2005

(54) Hot-melt adhesive compositions

(75) Inventors: Gerd Hohner, Gersthofen (DE); Sebastijan Bach, Langweid (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/166,481

(22) Filed: Jun. 24, 2005

(30) Foreign Application Priority Data
Jun. 25, 2004 (DE) 10 2004 030 714.8

(51) Int. Cl. C08K 5/05; C08K 5/01

(52) U.S. Cl. 524/384; 524/487

(57) ABSTRACT

The invention provides hot-melt adhesive compositions comprising
a) 5% to 99.995% by weight of a polyolefin of one or more C₃-C₁₈ α-olefins and also, if desired, ethylene, b) 0.005% to 2% by weight of one or more nucleators, c) 0 to 50% by weight of tackifier resin, and d) 0 to 30% by weight of wax.

The present invention is described in the German priority application No. 10 2004 030 714.8, filed Jun. 25, 2004, which is hereby incorporated by reference as is fully disclosed herein.

The invention provides hot-melt adhesive compositions which comprise polyolefins and nucleators. Further provided by the invention is a method of targetedly adjusting the open time of hot-melt adhesive compositions.

Hot-melt adhesives are solvent-free adhesives which are applied in the hot, liquid-melt state to the substrates to be bonded and which develop their adhesive effect after they solidify. Because of their multifarious advantages they are increasingly being used in industries including those of packaging, furniture, textiles, and footwear as an economic and environment-friendly alternative to conventional solvent-based adhesives. Important constituents of common hot-melt adhesive formulas are polar or nonpolar polymers, e.g., polymers of olefinic hydrocarbons or ethylene-vinyl acetate copolymers, resins, and waxes.

Nonpolar polymeric olefinic hydrocarbons display a variety of advantages in hot-melt adhesive compositions as compared with ethylene-vinyl acetate copolymers. Examples include improved thermal stabilities, more favorable processing properties in respect of stringing or cracking, and better adhesive properties.

The use of olefin copolymers of propylene and ethylene or higher 1-olefins in hot-melt adhesive formulas is described for example in EP-A-1 263 909. EP-A-0 886 656 describes hot-melt adhesives comprising copolymers of ethylene and butene or higher 1-olefins. U.S. Pat. No. 5,548,014 claims the use of olefin copolymers in hot-melt adhesives.

Hot-melt adhesives which comprise such olefin copolymers generally have comparatively long open times. The open time is defined as the period of time within which adhesive bonding is possible, counted from the moment when the hot-melt adhesive composition is applied to the substrate that is to be bonded. High-speed processing machines require short open times, which are frequently not present in the case of formulas containing olefin copolymers. Although the open time can be abbreviated by adding polyethylene waxes or paraffins, this entails an unwanted reduction in the bond strength of the hot-melt adhesive. There is therefore a need for polyolefin-based hot-melt adhesives with a short open time, or for a possibility of flexibly controlling the open time, with little cost or inconvenience, and of adapting it to the respective processing conditions without at the same time having to accept disadvantages with regard to the profile of action.

It has now been found that the open time can be targetedly influenced in this way by adding small amounts of a nucleator.

The present invention accordingly provides hot-melt adhesive compositions comprising
a) 5% to 99.995% by weight of a polyolefin of one or more C₃-C₁₈ α-olefins and also, if desired, ethylene,
b) 0.005% to 2% by weight of one or more nucleators,
c) 0 to 50% by weight of tackifier resin, and
d) 0 to 30% by weight of wax.

Preferably these hot-melt adhesive compositions comprise
a) 5% to 94.995% by weight of a polyolefin of one or more C₃-C₁₈ α-olefins and also, if desired, ethylene,
b) 0.005% to 2% by weight of one or more nucleators,
c) 5% to 50% by weight of tackifier resin, and
d) 0 to 20% by weight of wax.

The polyolefin preferably has a ring & ball softening point of between 40 and 160° C., preferably between 80 and 140° C., and a melt viscosity, measured at 170° C., of between 40 and 100 000 mPa.s, preferably between 60 and 50 000 mPa.s.

The polyolefin is preferably composed of propylene units and ethylene units.

Preferred nucleators used are compounds from the class of the alkali metal, alkaline earth metal or aluminum salts of carboxylic acids or from the class of the bisbenzylidenesorbitans.

Particularly preferred nucleators used are bisbenzylidenesorbitans.

The invention further provides, finally, a method of targetedly shortening the open time of the hot-melt adhesive compositions of the invention, which comprises controlling the shortening of the open time by means of the identity and concentration of the nucleator.

Suitable polyolefins include copolymers of ethylene with α-olefins of chain lengths C₃-C₁₈ or homopolymers of these α-olefins or their copolymers with one another. The polyolefins can be prepared by conventional methods, e.g., by catalytic polymerization of the olefins. Suitable catalysts include, for example, Ziegler-Natta catalysts or else metallocene catalysts. The preparation of products of this kind is described for instance in Ullmann's Encyclopedia of Industrial Chemistry, 5th ed., Vol. A 21, pp. 500-504, 509-514, 518-530 (Weinheim 1992). Low molecular mass polyolefins prepared using metallocene catalysts are described for example in EP-A-0 384 264. The polyolefins have a ring & ball softening point of between 40 and 160° C., preferably 80 to 140° C., and a melt viscosity, measured at 170° C., of between 40 and 100 000 mPa.s, preferably 60 to 50 000 mPa.s.

The melt viscosities here are determined in accordance with DIN 53019 using a rotational viscometer and the ring & ball softening points here are determined in accordance with DIN EN 1427.

As nucleators it is possible to use customary nucleating agents. Suitable such agents are, for example, salts of organic acids, such as aliphatic monocarboxylic or dicarboxylic acids, examples being alkali metal, alkaline earth metal or aluminum salts of succinic acid, glutaric acid, caproic acid, montanic acid or corresponding salts of carboxylic acids containing aromatic groups, such as benzoic, alkylbenzoic, naphthoic, phenylacetic or cinnamic acid. Also suitable are adjuvants based on phosphoric acid, examples being alkali metal organophosphates. Also effective are ionomers, examples being corresponding commercial products such as the grades from the Aclyn® range (commercial products from Honeywell) or from the Surlyn® range (commercial products from Dupont). Likewise suitable are nucleators of the dibenzylidenesorbitol type, not only in the unsubstituted form but also in the singly or multiply alkyl-substituted form, methyl-substituted for example. Preferred nucleators are dibenzylidenesorbitols. The amounts used, based on the polyolefin employed, are between 0.005% to 2.0%, preferably between 0.1% and 0.6% by weight.

Examples of suitable tackifier resins include synthetic or modified terpene resins, fully or partly hydrogenated rosins, aliphatic hydrocarbon resins, and hydrogenated and/or otherwise-modified aliphatic, aliphatic-aromatic or aromatic hydrocarbon resins. The hot-melt adhesive blend of the invention comprises resins in fractions between 0 and 50% by weight, preferably between 0 and 30% by weight.

Waxes which can be used include natural, possibly refined products, examples being microcrystalline or macrocrystalline paraffins or fully refined waxes, and also synthetic waxes such as polyethylene waxes, polypropylene waxes or Fischer-Tropsch waxes. Waxes may be present in the hot-melt adhesive blend in fractions between 0 and 30%, preferably 0 and 10% by weight.

Further possible constituents of the hot-melt adhesive blend are nonpolar or polar polymers such as, for example, ethylene-vinyl acetate copolymers, atactic polyalphaolefins (APAOs), polyisobutylene, styrene-butadiene-styrene block polymers or styrene-isoprene-styrene block polymers, and, for particularly high-performance bonds, polyamides or polyesters. The hot-melt adhesive compositions may further comprise fillers or auxiliaries such as plasticizers, e.g., hydrocarbon oils, pigments, and antioxidants.

### EXAMPLES

The “open time” of various polyolefins suitable for hot-melt adhesive preparation was compared with and without addition of nucleator.

Experimental Procedure:

The product under test is applied as a melt at 180° C. to a commercially customary card with dimensions of 15×35 cm by means of a frame-type doctor blade in a film thickness of 500 μm. At the beginning of drawdown, a stopwatch is started and at appropriate intervals of time (usually 5 s) a commercially customary standard paper measuring 2×8 cm is adhered until it is no longer possible to ascertain any tendency toward adhesion on the part of the applied adhesive. Where appropriate it may be necessary to modify the time intervals.

The open time is the period of time after which 100% substrate fiber extraction is observed.

Nucleators used were dibenzylidenesorbitol (Ciba® Irgaclear® D) and dimethyidibenzylidenesorbitol (Ciba® Irgaclear® DM) (commercial products from Ciba Specialty Chemicals).

The polyolefins used were as follows:

### Examples 1 and 2

®TP Licocene PP 1602: commercial product from Clariant GmbH, low molecular mass polypropylene, prepared using metallocene catalyst, melt viscosity approximately 7000 mPa.s/170° C., MFR_{230/2.16} 3500 g/10 min (measured in accordance with ASTM D1238-01), ring & ball softening point approximately 85° C.;

### Example 3

Low molecular mass propylene polymer, prepared using metallocene catalyst, melt viscosity approximately 7000 mPa.s/170° C., MFR_{230/2.16} 3700 g/10 min (measured in accordance with ASTM D1238-01), ring & ball softening point approximately 100° C.;

### Example 4

®Vestoplast 703: amorphous poly-α-olefin, commercial product from Degussa AG, melt viscosity at 170° C. approximately 4000 mPa.s, ring & ball softening point 125° C.

Results:

| | Nucleator | | Open time |
|---|---|---|---|
| Example | Type | Amount (% by weight) | seconds |
| 1 | ®Irgaclear D | 0 | 90 |
| | | 0.03 | 30 |
| | | 0.06 | 10 |
| | | 0.09 | <5 |
| 2 | ®Irgaclear DM | 0 | 90 |
| | | 0.03 | 25 |
| | | 0.06 | 5 |
| | | 0.09 | <5 |
| 3 | ®Irgaclear D | 0 | 25 |
| | | 0.03 | 10 |
| | | 0.06 | 5 |
| | | 0.09 | <5 |
| 4 | ®Irgaclear D | 0 | 30 |
| | | 0.03 | 30 |
| | | 0.09 | 15 |
| | | 0.15 | 15 |

The examples show that through the inventive addition of nucleator it is possible to achieve a reduction in the open time within a wide range. Targeted adjustment in accordance with the respective performance requirement is possible.

1. A hot-melt adhesive composition comprising
a) 5% to 99.995% by weight of a polyolefin of one or more C₃-C₁₈ α-olefins and optionally, ethylene,
b) 0.005% to 2% by weight of one or more nucleators,
c) 0 to 50% by weight of a tackifier resin, and
d) 0 to 30% by weight of a wax.

2. The hot-melt adhesive composition as claimed in claim 1, comprising
a) 5% to 94.995% by weight of a polyolefin of one or more C₃-C₁₈ α-olefins and optionally ethylene,
b) 0.005% to 2% by weight of one or more nucleators,
c) 5% to 50% by weight of the tackifier resin, and
d) 0 to 20% by weight of the wax.

3. The hot-melt adhesive composition as claimed in claim 1, wherein the polyolefin has a ring & ball softening point of between 40 and 160° C., and a melt viscosity, measured at 170° C., of between 40 and 100 000 mPa.s.

4. The hot-melt adhesive composition as claimed in claim 1, wherein the polyolefin is composed of propylene units and ethylene units.

5. The hot-melt adhesive composition as claimed in claim 1, wherein the one or more nucleators used are compounds from the class of alkali metal, alkaline earth metal or aluminum salts of carboxylic acids or from the class of the bisbenzylidenesorbitans.

6. The hot-melt adhesive composition as claimed in claim 1, wherein one or more nucleators is a bisbenzylidenesorbitan.

7. A method of targetedly shortening the open time of a hot-melt adhesive composition as claimed in claim 1, comprising the step of controlling the shortening of the open time by altering the composition and concentration of the one or more nucleators.

8. The hot-melt adhesive composition as claimed in claim 1, wherein the polyolefin has a ring & ball softening point of between 80 and 140° C., and a melt viscosity, measured at 170° C., of between 40 60 and 50 000 mPa.s.

9. An article comprising a first substrate and a second substrate, wherein the first substrate is bonded to the second substrate by the hot melt adhesive composition as claimed in claim 1.
